(19) United States
(12) Patent Application Publication
(10) Pub. No.: US 2025/0045275 A1
(43) Pub. Date: Feb. 6, 2025

(54) SYSTEM DESIGN DISCOURSE

(71) Applicant: International Business Machines Corporation, Armonk, NY (US)

(72) Inventors: SIDDHARTH K. SARAYA, Raniganj (IN); Mukundan Sundararajan, Bangalore (IN)

(21) Appl. No.: 18/228,551

(22) Filed: Jul. 31, 2023

(51) Int. Cl. G06F 16/2453

(52) U.S. Cl. CPC G06F 16/24542

(57) ABSTRACT

One embodiment provides a method including capturing, by a computing device, first information and deliverable information. Traceability is set up across the first information and deliverable information to identify gaps in the first information and the deliverable information. The first information and the deliverable information are analyzed and mapped to layers based on consumers of information. Objectivity in the first information and the deliverable information in each of the layers is determined. The deliverable information that is created during an entire development lifecycle is broken down to mapping the deliverable information to interrogative keywords for the layers. The first information is consumed upon the consumers of information having a discourse with a computing system.

### BACKGROUND

The field of embodiments of the present invention relates to a discourse query system that utilizes a level map based on the end user consumption.

Information on rational decision making in product design is not available after various changes and time lapse. Questions can arise in users on the rationale for a particular feature/function. After some time elapses, usage patterns could vary with users coming up with improvement/enhancement needs that could fit in well if information on the architecture/design rationale could be available.

### SUMMARY

Embodiments relate to a discourse query system that utilizes a level map based on the end user consumption. One embodiment provides a method including capturing, by a computing device, first information and deliverable information. Traceability is set up across the first information and deliverable information to identify gaps in the first information and the deliverable information. The first information and the deliverable information are analyzed and mapped to layers based on consumers of information. Objectivity in the first information and the deliverable information in each of the layers is determined. The deliverable information that is created during an entire development lifecycle is broken down to mapping the deliverable information to interrogative keywords for the layers. The first information is consumed upon the consumers of information having a discourse with a computing system.

A computer system and a computer program product configured to perform the above-described method are also disclosed herein.

These and other features, aspects and advantages of the present embodiments will become understood with reference to the following description, appended claims and accompanying figures.

### BRIEF DESCRIPTION OF THE DRAWINGS

FIG. 1 illustrates a system architecture for defining end user levels, mapping a query/concern to the user level and providing a representation of analysis structure data, according to one embodiment;

FIG. 2 illustrates a system flow diagram, according to one embodiment;

FIG. 3 illustrates a process for using a computing device to perform processing for a discourse query system that utilizes a level map based on the end user consumption, according to an embodiment; and

FIG. 4 illustrates an example computing environment utilized by one or more embodiments.

### DETAILED DESCRIPTION

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Embodiments relate to a discourse query system that utilizes a level map based on the end user consumption. One embodiment provides a method including capturing, by a computing device, first information (e.g., assumptions, requirements, design, code, reviews, tests and alternatives per phase of development) and deliverable information. Traceability is set up across the first information and deliverable information to identify gaps in the first information and the deliverable information. The first information and the deliverable information are analyzed and mapped to layers based on consumers of information. Objectivity in the first information and the deliverable information in each of the layers is determined. The deliverable information that is created during an entire development lifecycle is broken down to mapping the deliverable information to interrogative keywords for the layers. The first information is consumed upon the consumers of information having a discourse with a computing system. The embodiments significantly improve design discourse. Some of the features contribute to the advantage of storing data in a level consumer map, i.e., per deliverable/consumable point of the end user, hence the traceability works right to left as right most items are the pieces seen and felt by consumers. The embodiments further contribute to the advantage that based on each consumer query/concern, the logical reasoning for the decision and options considered while taking the decision are derived. Still further, embodiments contribute to the advantage that they are able to either find responses for consumers or be able to take inputs for reconsideration with subject matter experts (SMEs) to understand why it was not considered and to be consumed in any such future venture.

A computer system and a computer program product configured to perform the above-described method are also disclosed herein.

One or more of the following features may be included. In some embodiments the consumers of information comprise end users, maintenance teams and technical owners.

In one or more embodiments, the objectivity in the first information and the deliverable information is stored in a referenceable way. The objectivity in the first information and the deliverable information includes mapping against decision, alternatives considered, decision parameters, and cost-benefit ratio.

In some embodiments, the first information and the analysis are mapped to the layers on an objective basis, and rationalizing subjective content to bring about objective end to end traceability for interrogative queries.

In one or more embodiments, discourse is held as an exchange of concerns about the application or the system to which using APIs, objective data appropriate to a query in a concern is presented back in a scientific manner.

In some embodiments, upon an exchange terminating with responses measured as being incomplete, a computing device (or processor) pushes the exchange to stakeholders.

Requirement, Design or Code/Build are completed as per the need time when processed. This is limited to a few discussions, brainstorming, etc., but largely as mentioned on the need of the time. These details are captured in one or more collaborative (life cycle management) tools. But the problem arises after some years, when users use/see it, they start saying that why was it designed/built in this manner. Could they have not thought of making it differently? And more such similar questions/comments. The end user is not at fault as with the passage of time situations have changed, and now the user may see it as a bad requirement/design/code. Here an intelligent system is needed, where the end user identifies an opportunity of improvement in terms of questions or comment(s), and can raise the same and be provided with the response derived from a collaborative tool (e.g., a software application, etc.) and receive a response.

Conventional techniques mention system design and requirements mapping. These techniques show how changes in the requirements are mapped to the design. Distinguishable, none of these conventional systems provide a level (or leveled) map where each deliverable has a point of interaction that is connected to a level consumer map, which derives the relevant requirement, design, solutions considered, choice proceeded with, etc. The embodiments significantly improve the query processing since based on a query (e.g., search query, etc.), relevant data is presented, and if a sticky point is identified that was not considered during construction of the deliverable it is taken as an input and shared with the relevant stakeholder for further analysis and consumption.

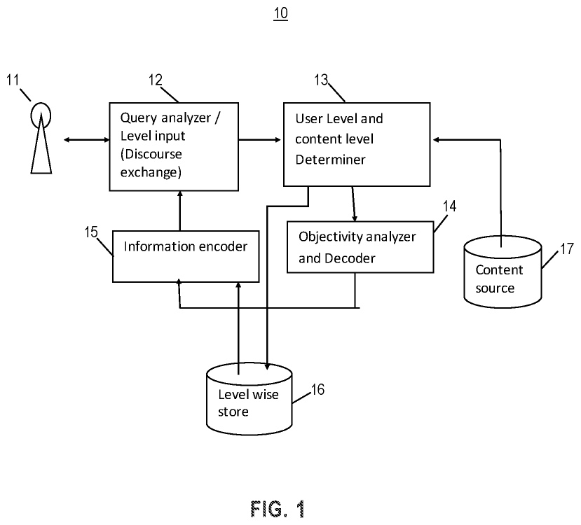

FIG. 1 illustrates a system architecture 10 for defining end user levels, mapping a query/concern to the user level and providing a representation of analysis structure data, according to one embodiment. In some embodiments, the system architecture includes a query analyzer/level input (discourse exchange) 12 that interacts with an end user 11, a user level and content level determiner 13, an objectivity analyzer and decoder 14, information decoder 15, a level wise store (e.g., database, storage device, etc.) 16 and a content source (e.g., database, storage device, etc.) 17.

Some embodiments provide mapping for end user consumers at each stage of the process, and for each deliverable for consumers, the system prepares a level consumer map. In one or more embodiments, the level map works for traceability establishments from right to left. In some embodiments, right most items are end products for each consumer level consumed deliverable. Each deliverable has the points of interaction. In some embodiments, generated tree mapping includes the assumptions, decisions, alternate solutions, etc., affecting each interaction point that is derived and mapped. This data is exposed in a manner that on any user raising a concern, that user may be presented with the logic undertaken for that architecture/design/code. Further, based on the query if a sticky point is identified that is raised by the deliverable consumer, and the system identifies that it was not discussed, then the concerned logic is further shared with the system/application owner for their consumption.

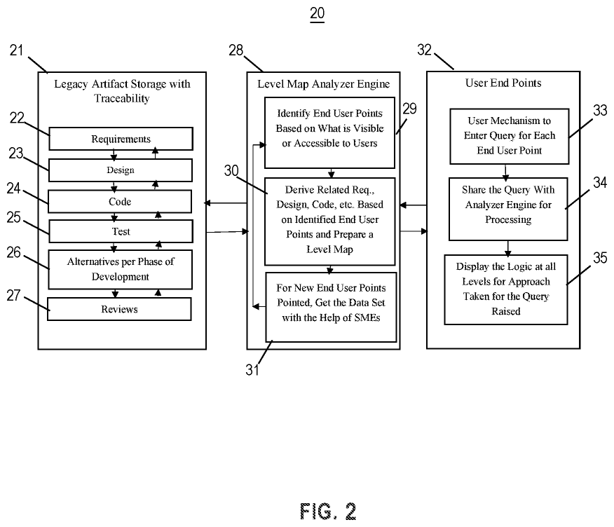

In one or more embodiments, a new model of information is represented as content. Some embodiments determine the facts in the content, the instantiation of the facts as data representation if any and capturing the intent of the author or their thread of thinking. One or more embodiments looks at concepts, contexts and prior information structure from an author for the event/session as it creates the proposed information structure. Some embodiments look at the text or textual representation of images, audio, video (enabling art) and determine the facts from the content. In one or more embodiments, the system determines if a noun/adverb/verb is a fact by applying the conditions that it is something that may be sensed in some form or other by a sensor as an extension of human senses; and if it can be described by using the hands/limbs of a user (meaning it can show up as an image). This enables one to detect if it is a fact or an abstract concept. If there is an abstraction as the word represents an instantiation, then such an abstraction as determined by either group representation synonyms or other hierarchical terms is used as the fact. Thus, the content is analyzed to determine the facts and the instantiations. In some embodiments, there is a construct for the facts, instantiations, concepts, and line of thought. In one or more embodiments, information security policies are defined/documented and provided as input to the level map analyzer engine 28 (FIG. 2) that creates rules from a document where necessary. The incoming information is checked for the facts and instantiation against the rules and if anything is to be hidden due to rule exception, that is pointed out (e.g., messaging sent, displayed, report generation, etc.).

FIG. 2 illustrates a system flow diagram 20, according to one embodiment. In some embodiments, the system flow diagram 20 includes a legacy artifact storage with traceability 21, a level map analyzer engine 28 and user end points 32. In one or more embodiments, assumptions, requirements 22, design 23, code 24, test 25 and reviews 27 are captured in a collaborative tool (e.g., a software application, etc.). Alternatives (e.g., options considered for each piece) per phase of development 26 are also captured in the collaborative tool. In one embodiment, in the alternatives per phase of development 26 implemented with the collaborative tool, the cost benefit analysis of why the implemented solution versus the alternate options is also captured. In some embodiments, the collaborative tool includes a provision to capture the above-mentioned information in a structured manner. In some embodiments, the capturing of the information may be implemented with known technology.

In one or more embodiments, an analyzer (query analyzer/level input 12, FIG. 1) performs analyzing the traceability for each of the artifacts delivered across phases. The analyzer additionally analyzes the thought process for each piece of a solution, and identifies if there are assumptions, alternate options and performs a cost benefit analysis of the options. If any of these assumptions, and alternate options are found missing, an owner of that artifact is alerted to update. For example, if for some artifacts any of the parameters is missing, the owner needs to confirm this using the collaborative tool. This helps in capturing the thought process for each piece of solution developed.

In some embodiments, the data after this analysis is processed by the level map analyzer engine 28 to map to end deliveries that an end user would consume/use. This starts with block 29 that identifies end user points based on what is visible or accessible to users. Block 29 performs identification of what the end user is consuming. Here the end user consumers might vary at each level. Just as coders would be consumers for design and requirements, clients would be consumers for requirements 22, design 23, code 24, test 25, reviews 27, etc. The layers of consumers are defined, and based on the identification, end points of deliveries consumed are identified. This analyzed data is stored in the level wise store 16 (FIG. 1).

In one or more embodiments, in block 30 related requirements 22, design 23, code 24, test 25, reviews 27, etc. are derived based on end user points. A level map is also prepared in block 30. In block 31, for new end user points pointed, the system gets the data set with the help of SMEs. At the end of this, each consumed deliverable is broken down in a manner that the user would consume. This is based on what data the user inputs or gets as outputs. In some embodiments, additional considerations may be time, ease of use, etc. For example, when code is being written where a function is being called and results in certain output, the considered values are input and output values. In one example of a function A:
Function A (Integer B, Integer c) {
Integer D=B+C;
Output D;
}
   In this example, the values of consideration would be B, C, D. Then the requirement and design decision for why two variables are being input, added and output provided are mapped. In some embodiments, similarly on a graphical user interface (GUI) screen, a user sees two input boxes and an output box. Then the options considered from requirements 22, design 23, code 24 and test 25 are fetched. While fetching the data, the intent of the decision is mapped. The mapped analyzed data is stored on one or more servers in the level wise store 16 (FIG. 1).

In one or more embodiments, the data is exposed using APIs that take input and pull out the reasons for the artifact or system to behave in that manner. In one embodiment, this is performed using a mechanism upon an end user raising a concern. Each application is provided an interface, where the user can raise the concern. In some embodiments, this processing may implement conventional techniques.

In some embodiments, concern (of the user) is mapped to the layer to which that user belongs. Then the concern is mapped to the field for which concern is raised. From the analyzed data structure, relevant assumptions, logic and alternate solutions with their cost benefit analysis are fetched. This analysis is presented to the consumer for his/her consumption.

In one or more embodiments, in the user end points processing 32, in block 33 the user is provided a user mechanism (e.g., a GUI, API, etc.) to enter a query for each end user point. In block 34, the query is shared with the level map analyzer engine 28 for processing. In block 35, the logic at all levels for approach taken for the query raised is displayed. The display of the analysis user feedback would be requested to understand if the intent of the user question is satisfied. If the user acknowledges that they are completely satisfied, then no further analysis is performed. For unsatisfied users, the input question/concern is sent to the supervised learning team (SMEs) to further refine the end point map and the user analysis map.

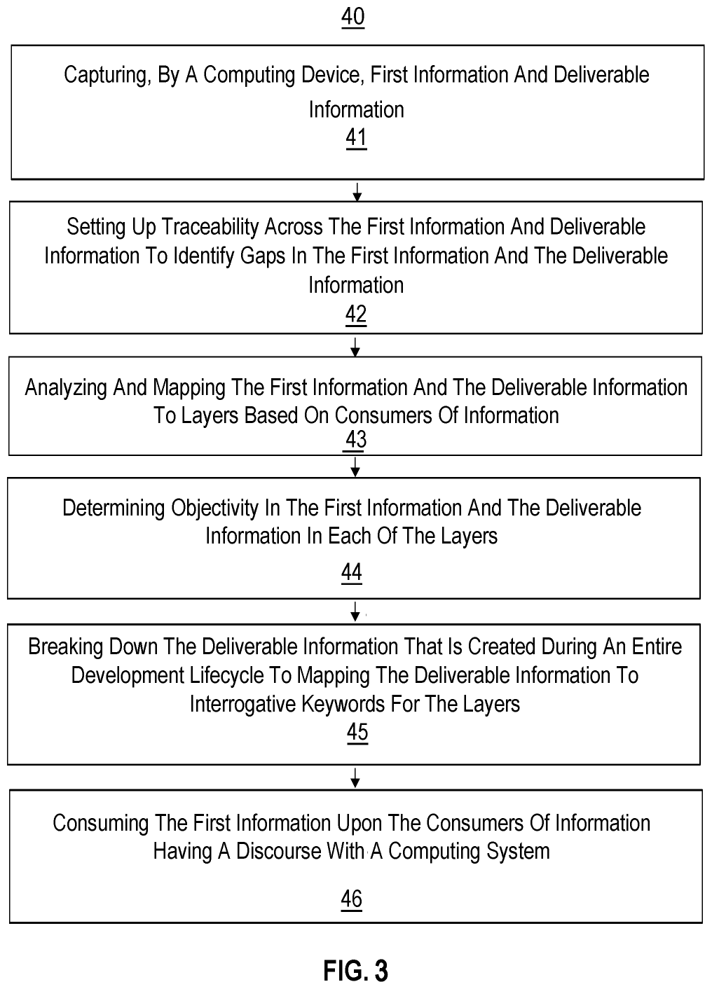

FIG. 3 illustrates a process 40 for using a computing device to perform processing for a discourse query system that utilizes a level map based on the end user consumption, according to an embodiment. In one embodiment, in block 41 process 40 performs capturing, by a computing device, first information (e.g., assumptions, requirements, design, code, reviews, tests and alternatives per phase of development) and deliverable information. In block 42, process 40 performs setting up traceability across the first information and deliverable information to identify gaps in the first information and the deliverable information. In block 43, process 40 performs analyzing and mapping the first information and the deliverable information to layers based on consumers of information. In block 44, process 40 performs determining objectivity in the first information and the deliverable information in each of the layers. In block 45, process 40 performs breaking down the deliverable information that is created during an entire development lifecycle to mapping the deliverable information to interrogative keywords for the layers. In block 46, process 40 performs consuming the first information upon the consumers of information having a discourse with a computing system. Thus, the process 40 achieves design discourse with the advantage of storing data in a level consumer map, i.e., per deliverable/consumable point of the end user, hence the traceability works right to left as right most items are the pieces seen and felt by consumers. Process 40 contributes to the advantage that based on each consumer query/concern, the logical reasoning for the decision and options considered while taking the decision are derived. Process 40 further contributes to the advantage that it is able to either find responses for consumers or be able to take inputs for reconsideration with SMEs to understand why it was not considered and to be consumed in any such future venture.

In one or more embodiments, process 40 may further include the feature that the first information is generated in various phases and comprises information about a system or an application, and the deliverable information comprises requirements, architecture, design, pseudo-code, and verification information.

In one or more embodiments, process 40 may include the feature that the consumers of information comprise end users, maintenance teams and technical owners.

In some embodiments, process 40 may further include processing for storing the objectivity in the first information and the deliverable information in a referenceable way. The objectivity in the first information and the deliverable information includes mapping against decision, alternatives considered, decision parameters, and cost-benefit ratio.

In one or more embodiments, process 40 may further include processing for mapping the first information and the analysis to the layers on an objective basis, and rationalizing subjective content to bring about objective end to end traceability for interrogative queries.

In some embodiments, process 40 may include the feature that discourse is held as an exchange of concerns about the application or the system to which using APIs, objective data appropriate to a query in a concern is presented back in a scientific manner.

In one or more embodiments, process 40 may further include the feature that upon an exchange terminating with responses measured as being incomplete, a computing device (or processor) pushes the exchange to stakeholders.

In one example embodiment, a use case for a residential building is described as follows. In some embodiments, the starting point is the requirement of what the end user expects in the building, such as three (3) rooms with attached bathrooms, one (1) dining room, a living room, a kitchen, and a garden. These requirements are captured in the collaborative tool (e.g., a software application, etc.) and then a design prepared that provides an overview of what the building would look like. In one or more embodiments, the collaborative tool maps with the dimensions of the land. Then a lower-level design is prepared with the overall size of each room, layout, gates, windows, etc. This is reviewed and the final construction is performed as per the design. While in construction there may be changes based on some feasibility and run time decisions that are recorded in the collaborative tool. It can be seen that there is traceability beginning from the requirement to the final delivered residential building, i.e., left to right traceability. Further, while generating a level map, the map is prepared based on the end user consumption; just as it would involve gates, windows, air conditioners, and other parameters. Hence the collaborative tool derives all the related construction points, low- and high-level design, reviews and requirements related to each consumable item. This level map might not have all the consumption points listed at one go. Therefore, in one or more embodiments the level map is an extendible map, which as consumers point out would add to the level map and try to derive related points. Therefore, the same may be shared with the consumer. For example, a consumer is trying to put a nail on the wall and has query or concern for the same. Then the wall and cement related quality details are fetched. If there are no responses or details found, then the query/observation would be shared with the SMEs.

In another example embodiment, a use case for a software financial application is described as follows. The starting point is the requirement of what the end user expects from the application for financial payments. For example, the collaborative tool may need a user to register with details in order to be able to login. The end user may then choose the payee to make a payment and logoff. This requirement is captured in the collaborative tool and then a design is prepared that provides an overview of what the software financial application would look like. In some embodiments, the collaborative tool maps with the usage flow, and load capacity. Then a lower-level design is generated per functionality or per module/process of how that independent system would work, in terms of the compliances. In one or more embodiments, the design is reviewed at each step and final coding is generated as per the design. While coding there would be changes based on some feasibility and run time decisions that are recorded in the collaborative tool. It can be seen that there is traceability beginning from the requirement to the final delivered software financial application, i.e., left to right traceability. While preparing a level map, it is prepared based on the end user consumption. For example, the map would involve registration fields, login screen, payment screen and its fields, logout screen and other parameters. Hence the collaborative tool derives all the related points, requirements, low- and high-level design, reviews and requirements related to each consumable item. This level map might not have all the consumption points listed at one go. Therefore, in some embodiments the level map is an extendible level map, which as consumers point out would add to the level map and try to derive related points, such that the same may be shared with the consumer. For example, a consumer is trying to make payment in decimals and has a query or concern for the same, then the related quality details are fetched. If there is no response or details found, then the query/observation would be shared with the SMEs.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

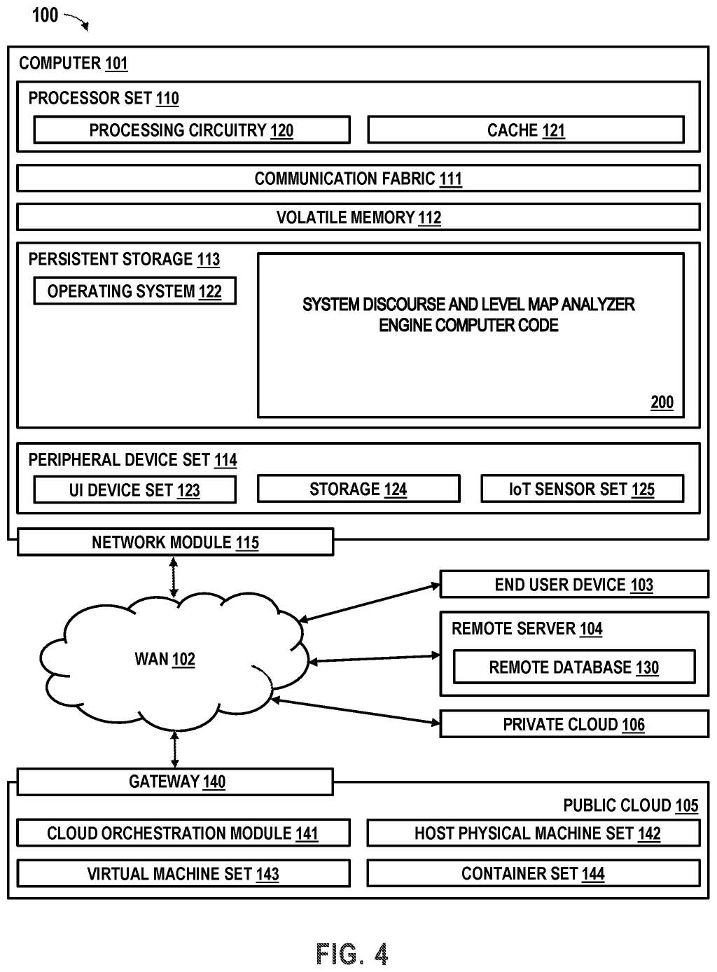

FIG. 4 illustrates an example computing environment 100 utilized by one or more embodiments. Computing environment 100 contains an example of an environment for the execution of at least some of the system discourse and level map analyzer engine computer code 200 involved in performing the inventive methods. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

References in the claims to an element in the singular is not intended to mean “one and only” unless explicitly so stated, but rather “one or more.” All structural and functional equivalents to the elements of the above-described exemplary embodiment that are currently known or later come to be known to those of ordinary skill in the art are intended to be encompassed by the present claims. No claim element herein is to be construed under the provisions of 35 U.S.C. section 112, sixth paragraph, unless the element is expressly recited using the phrase “means for” or “step for.”

The terminology used herein is for the purpose of describing particular embodiments only and is not intended to be limiting of the embodiments. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present embodiments has been presented for purposes of illustration and description, but is not intended to be exhaustive or limited to the embodiments in the form disclosed. Many modifications and variations will be apparent to those of ordinary skill in the art without departing from the scope and spirit of the embodiments. The embodiment was chosen and described in order to best explain the principles of the embodiments and the practical application, and to enable others of ordinary skill in the art to understand the embodiments for various embodiments with various modifications as are suited to the particular use contemplated.

What is claimed is:

1. A method comprising:
capturing, by a computing device, first information and deliverable information;
setting up traceability across the first information and deliverable information to identify gaps in the first information and the deliverable information;
analyzing and mapping the first information and the deliverable information to layers based on consumers of information;
determining objectivity in the first information and the deliverable information in each of the layers;
breaking down the deliverable information that is created during an entire development lifecycle to mapping the deliverable information to interrogative keywords for the layers; and
consuming the first information upon the consumers of information having a discourse with a computing system.

2. The method of claim 1, wherein the first information is generated in various phases and comprises information about a system or an application, and the deliverable information comprises requirements, architecture, design, pseudo-code, and verification information.

3. The method of claim 2, wherein the consumers of information comprise end users, maintenance teams and technical owners.

4. The method of claim 2, further comprising:
storing the objectivity in the first information and the deliverable information in a referenceable way;
wherein the objectivity in the first information and the deliverable information comprises mapping against decision, alternatives considered, decision parameters, and cost-benefit ratio.

5. The method of claim 2, further comprising:
mapping the first information and the analysis to the layers on an objective basis; and
rationalizing subjective content to bring about objective end to end traceability for interrogative queries.

6. The method of claim 2, wherein discourse is held as an exchange of concerns about the application or the system to which using application programming interfaces (APIs), objective data appropriate to a query in a concern is presented back in a scientific manner.

7. The method of claim 2, wherein upon an exchange terminating with responses measured as being incomplete, the computing device pushes the exchange to stakeholders.

8. A computer program product for providing logic at a plurality of levels for approach taken in response of a query, the computer program product comprising a computer readable storage medium having program instructions embodied therewith, the program instructions executable by a processor to cause the processor to:
capture first information and deliverable information;
set up traceability across the first information and deliverable information to identify gaps in the first information and the deliverable information;
analyze and map the first information and the deliverable information to layers based on consumers of information;
determine objectivity in the first information and the deliverable information in each of the layers;
break down the deliverable information that is created during an entire development lifecycle to mapping the deliverable information to interrogative keywords for the layers; and
consume the first information upon the consumers of information having a discourse with a computing system.

9. The computer program product of claim 8, wherein the first information is generated in various phases and comprises information about a system or an application, and the deliverable information comprises requirements, architecture, design, pseudo-code, and verification information.

10. The computer program product of claim 9, wherein the consumers of information comprise end users, maintenance teams and technical owners.

11. The computer program product of claim 9, wherein:
the program instructions executable by the processor further cause the processor to:
store the objectivity in the first information and the deliverable information in a referenceable way; and
the objectivity in the first information and the deliverable information comprises mapping against decision, alternatives considered, decision parameters, and cost-benefit ratio.

12. The computer program product of claim 9, the program instructions executable by the processor further cause the processor to:
map the first information and the analysis to the layers on an objective basis; and
rationalize subjective content to bring about objective end to end traceability for interrogative queries.

13. The computer program product of claim 9, wherein discourse is held as an exchange of concerns about the application or the system to which using application programming interfaces (APIs), objective data appropriate to a query in a concern is presented back in a scientific manner.

14. The computer program product of claim 9, wherein upon an exchange terminating with responses measured as being incomplete, the computing device pushes the exchange to stakeholders.

15. A system comprising:
a memory configured to store instructions; and
a processor configured to execute the instructions to:
capture first information and deliverable information;
set up traceability across the first information and deliverable information to identify gaps in the first information and the deliverable information;
analyze and map the first information and the deliverable information to layers based on consumers of information;
determine objectivity in the first information and the deliverable information in each of the layers;
break down the deliverable information that is created during an entire development lifecycle to mapping the deliverable information to interrogative keywords for the layers; and
consume the first information upon the consumers of information having a discourse with a computing system.

16. The system of claim 15, wherein the first information is generated in various phases and comprises information about a system or an application, and the deliverable information comprises requirements, architecture, design, pseudo-code, and verification information.

17. The system of claim 16, wherein the consumers of information comprise end users, maintenance teams and technical owners.

18. The system of claim 16, wherein the processor is further configured to execute the instructions to:
store the objectivity in the first information and the deliverable information in a referenceable way; and
the objectivity in the first information and the deliverable information comprises mapping against decision, alternatives considered, decision parameters, and cost-benefit ratio.

19. The system of claim 16, wherein the processor is further configured to execute the instructions to:
map the first information and the analysis to the layers on an objective basis; and
rationalize subjective content to bring about objective end to end traceability for interrogative queries.

20. The system of claim 16, wherein discourse is held as an exchange of concerns about the application or the system to which using application programming interfaces (APIs), objective data appropriate to a query in a concern is presented back in a scientific manner, and upon an exchange terminating with responses measured as being incomplete, the processor pushes the exchange to stakeholders.
